(19) United States
(12) Patent Application Publication
(10) Pub. No.: US 2012/0042877 A1
(43) Pub. Date: Feb. 23, 2012

(54) AIR PURIFIER AIR OUTLET STRUCTURE

(76) Inventors: Fu-Chi WU, Northridge, CA (US); Steven WU, Northridge, CA (US)

(21) Appl. No.: 12/857,738

(22) Filed: Aug. 17, 2010

(51) Int. Cl. A62B 7/10; B01D 46/42

(52) U.S. Cl. 128/205.27; 55/414; 55/415

(57) ABSTRACT

An air purifier air outlet structure includes one or a number of air outlets located on the housing of an air purifier adjacent to the air output port of the air purifier, a shutting device fastened to the housing of the air purifier to block the air output port for enabling purified air to pass out of the air purifier through the air outlet and a breathing tube having its one end connected to the air outlet(s) and its other end terminating in a respiratory device for enabling a user to breathe in purified air from the air purifier through the breathing tube so that the air purifier can be used in an office, house, car, factory, hospital or any other place as a personal air purifier to provide purified air for breathing by the user.

### BACKGROUND OF THE INVENTION

1. Field of the Invention

The present invention relates to air purifying technology and more particularly, to an air purifier air outlet structure, which comprises one or a number of air outlets located on the housing adjacent to the air output port of the air purifier, a shutting device fastened to the housing of the air purifier to block the air output port of the air purifier and enabling purified air to pass out of the air purifier through the air outlet and a breathing tube having its one end connected to the air outlet(s) and its other end terminating in a respiratory device for enabling a user to breathe in purified air from the air purifier through the breathing tube. Thus, the air purifier can be used in an office, house, car, factory, hospital or any other place as a personal air purifier to provide purified air for breathing by the user.

2. Description of the Related Art

In a regular indoor air purifier, the internal fan is operated to suck in air through an air input port thereof for filtration by an internal filter for enabling purified air to be sent out of an air output port, keeping the indoor air clean. However, conventional indoor air purifiers or car air purifiers can simply purify the air in an indoor or car space. These indoor air purifiers or car air purifiers cannot be used as a respiratory system to provide purified air for breathing by one or multiple users. If outdoor dirty air or atmosphere dirty air enters the indoor space or car interior space, every person in the house or every passenger in the car will breathe in dirty air. Further, when there is any person in a house or any passenger in a car who gets an infectious disease, the infectious disease may be transferred to other persons in the house or other passengers in the car. More particularly, when this situation occurs in a house of a public building, in a mass transportation vehicle or in a labor-intensive manufacturing line inside a factory, the air conditioning system cannot prevent transfer of the infectious disease.

### SUMMARY OF THE INVENTION

The main object of the present invention is to provide an air purifier air outlet structure, which comprises one or a number of air outlets located on the housing adjacent to the air output port of the air purifier, a shutting device fastened to the housing of the air purifier to block the air output port of the air purifier and enabling purified air to pass out of the air purifier through the air outlet and a breathing tube having its one end connected to the air outlet(s) and its other end terminating in a respiratory device for enabling a user to breathe in purified air from the air purifier through the breathing tube. Thus, the air purifier can be used in an office, house, car, factory, hospital or any other place as a personal air purifier to provide purified air for breathing by the user.

### BRIEF DESCRIPTION OF THE DRAWINGS

FIG. 1 is an exploded view of an air purifier air outlet structure in accordance with the present invention.

FIG. 2 is an elevational assembly view of FIG. 1.

FIG. 3 is a schematic drawing of the present invention, illustrating the air of respiratory nosepieces of the respiratory device of the breathing tube inserted into the nostrils of a person.

FIG. 4 is similar to FIG. 3, showing the respiratory device of the breathing tube made in the form of a respiratory mask.

FIG. 5 illustrates an alternate form of the air purifier air outlet structure in accordance with the present invention where three air outlets are located on the top side of the housing of the air purifier adjacent to the air output port.

FIG. 6 illustrates another alternate form of the air purifier air outlet structure in accordance with the present invention where two air outlets are located on one lateral side of the housing of the air purifier adjacent to the air output port.

FIG. 7 illustrates still another alternate form of the air purifier air outlet structure in accordance with the present invention where a horizontal louver shutter is mounted in the air output port.

FIG. 8 is a schematic sectional side view of the embodiment of FIG. 7, showing the horizontal louver shutter opened.

FIG. 9 corresponds to FIG. 8, showing the horizontal louver shutter closed.

FIG. 10 illustrates still another alternate form of the air purifier air outlet structure in accordance with the present invention where a sliding shutter is mounted in the air output port.

FIG. 11 is a schematic sectional side view of the embodiment of FIG. 10, showing the sliding shutter opened.

FIG. 12 corresponds to FIG. 11, showing the sliding shutter closed.

FIG. 13 illustrates still another alternate form of the air purifier air outlet structure in accordance with the present invention where a rotary shutter is mounted in the air output port.

FIG. 14 is a schematic sectional side view of the embodiment of FIG. 13, showing the rotary shutter opened.

FIG. 15 corresponds to FIG. 14, showing the rotary shutter closed.

FIG. 16 illustrates a shutting device with three air outlets used in the air output port of a conventional air purifier.

FIG. 17 is a schematic sectional view, illustrating the shutting device of FIG. 16 installed in the air output port of the conventional air purifier.

FIG. 18 is an elevational view, illustrating the shutting device of FIG. 16 installed in the air output port of the conventional air purifier, and breathing tubes connected to the air outlets of the shutting device.

### DETAILED DESCRIPTION OF THE PREFERRED EMBODIMENT

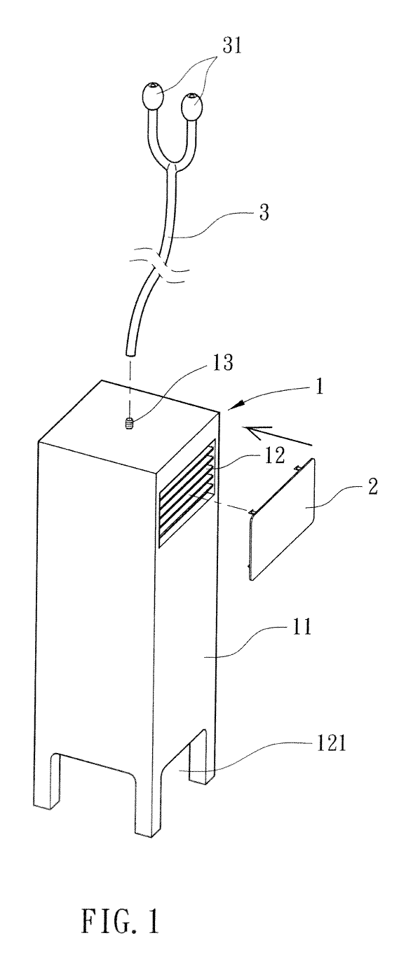

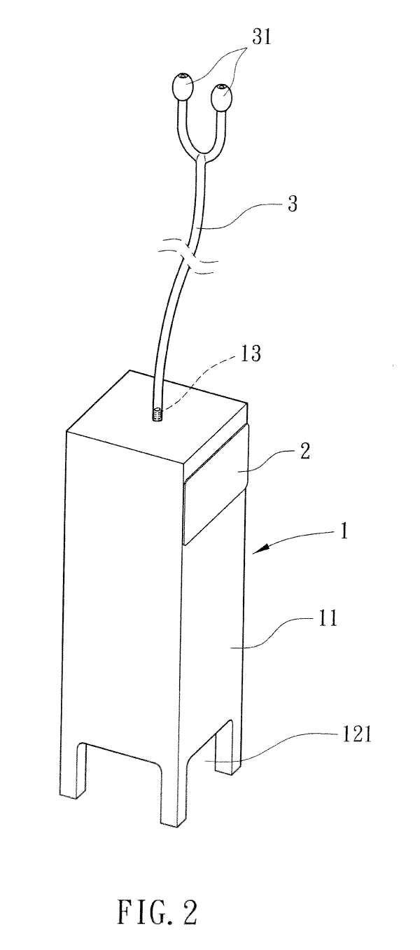

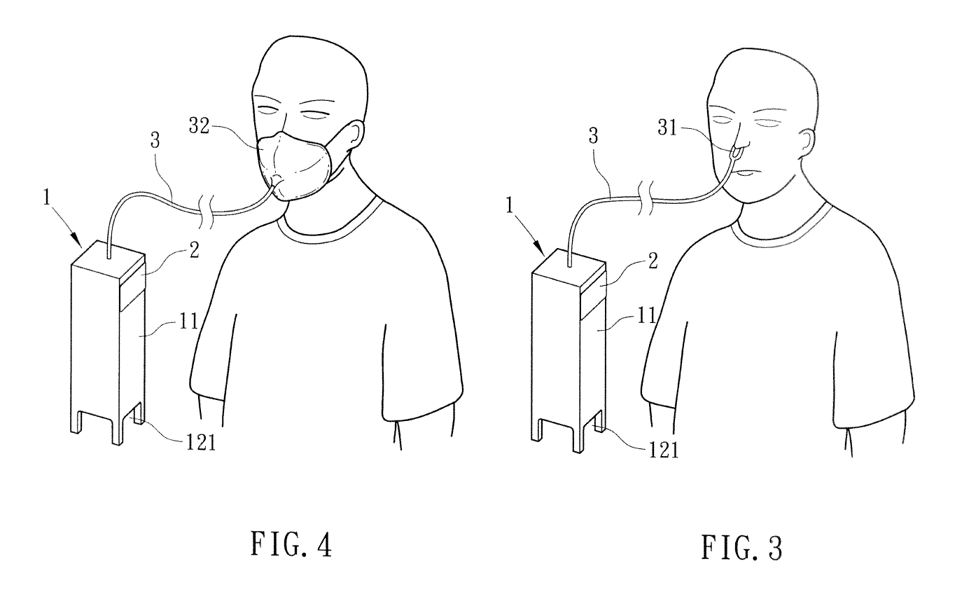

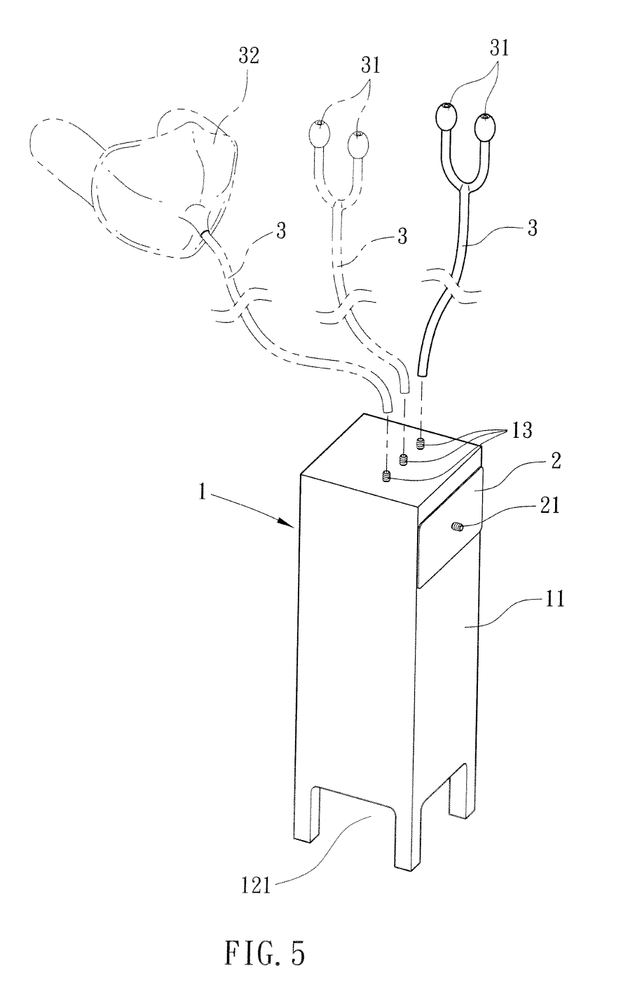

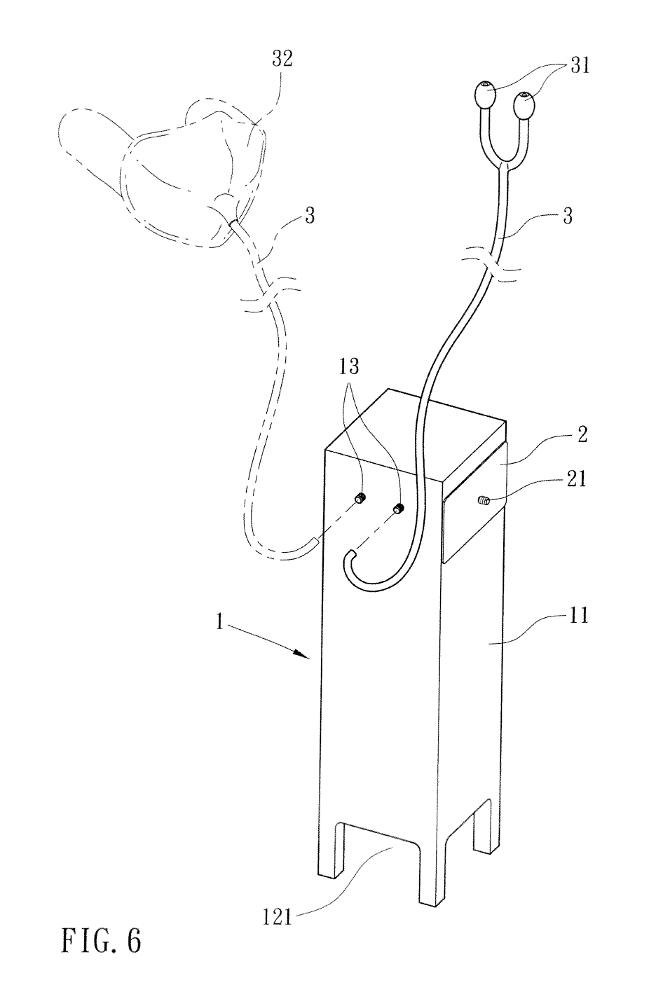

Referring to FIGS. 1˜6, an air purifier 1 air outlet 13 structure in accordance with the present invention is shown comprising one or a number of air outlets 13 located on the housing 11 of an air purifier 1 adjacent to the air output port 12 of the air purifier 1 and remote from the air input port 121, a shutting device 2 fastened to the housing 11 of the air purifier 1 to block the air output port 12 for enabling purified air to pass out of the air purifier 1 through the air outlet(s) 13 and at least one breathing tube 3 each having its one end connected to one air outlet 13 and its other end terminating in a respiratory device, for example, a pair of respiratory nosepieces 31 (see FIGS. 1˜3) or a respiratory mask 32 (see FIG. 4) for enabling a user to breathe in purified air from the air purifier 1 through the breathing tube 3 so that the air purifier 1 can be used in an office, house, car, factory, hospital or any other place as a personal air purifier 1 to provide purified air for breathing by the user.

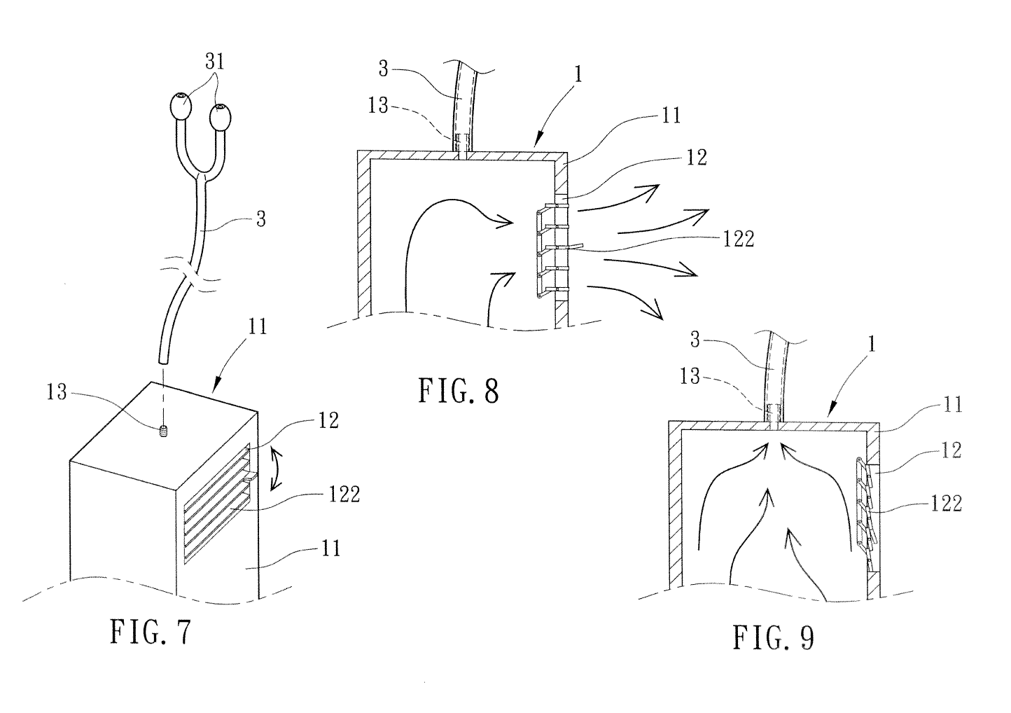

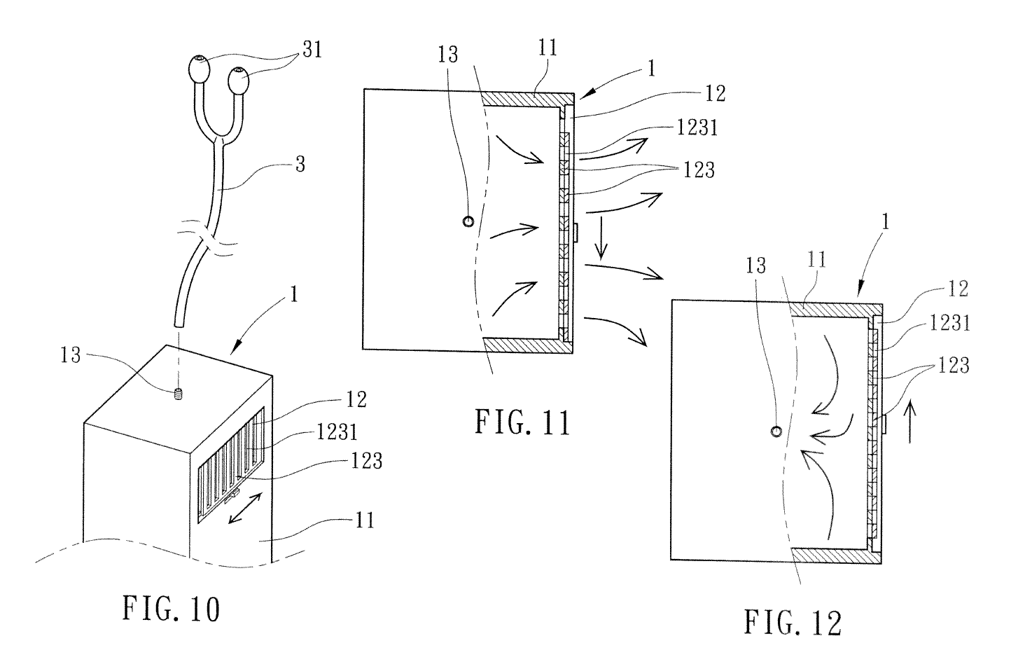

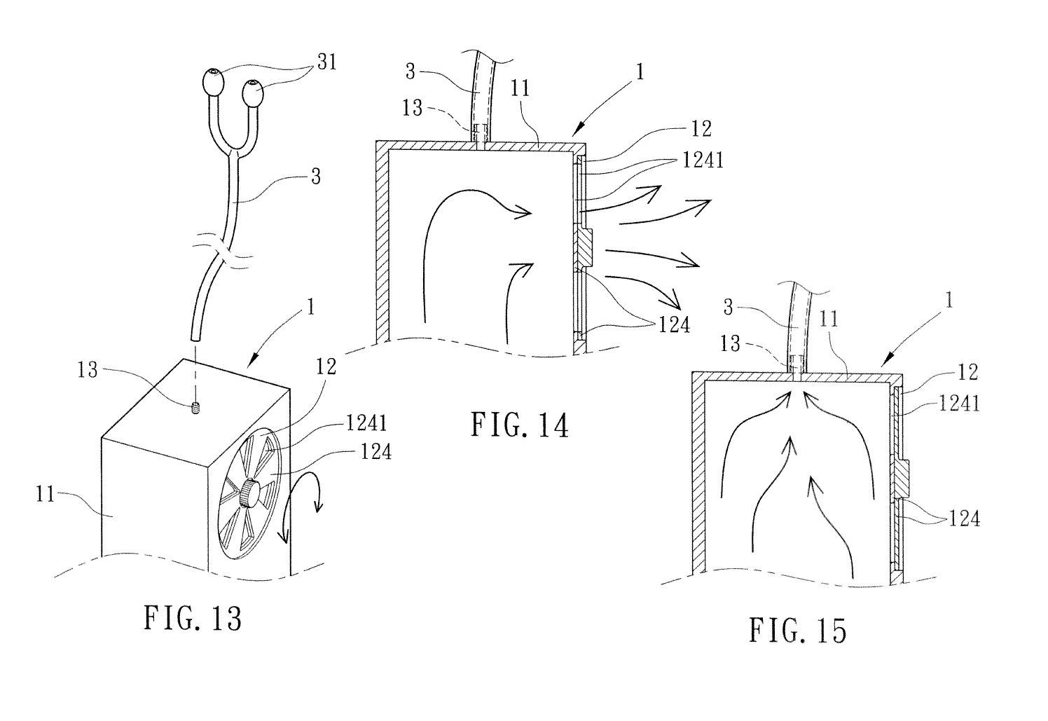

The aforesaid shutting device 2 can be a plate member, or a louver shutter 122. When a louver shutter 122 is used, it is installed in the air output port 12 of the air purifier 1, and biasable to close/open the air output port 12. When biasing the horizontal louvers of the louver shutter 122 to the close position, the louver shutter 122 blocks the air output port 12, allowing purified air to pass out of the air purifier 1 through the air outlet(s) 13 (see FIGS. 7˜9). Alternatively, the aforesaid shutting device 2 can be a sliding shutter 123 formed of two sets of parallel shutter slats. The shutter slats of one same set are arranged in parallel with an opening 1231 left between each two adjacent shutter slats. By means of sliding one set of parallel shutter slats relative to the other set of parallel shutter slats, the sliding shutter 123 is shifted between an open position where the parallel shutter slats of the two sets are aligned to open the openings 1231, and a close position where the openings 1231 in one set of parallel shutter slats are blocked by the other set of parallel shutter slats (see FIGS. 10˜12). Alternatively, the aforesaid shutting device 2 can be a rotary shutter 124 formed of two sets of radial shutter slats. The radial shutter slats of one same set are arranged in a radial manner with an opening 1241 left between each two adjacent radial shutter slats. By means of rotating one set of radial shutter slats relative to the other set of radial shutter slats, the rotary shutter 124 is shifted between an open position where the radial shutter slats of the two sets are aligned to open the openings 1241, and a close position where the openings 1241 in one set of radial shutter slats are blocked by the other set of radial shutter slats (see FIGS. 13˜15).

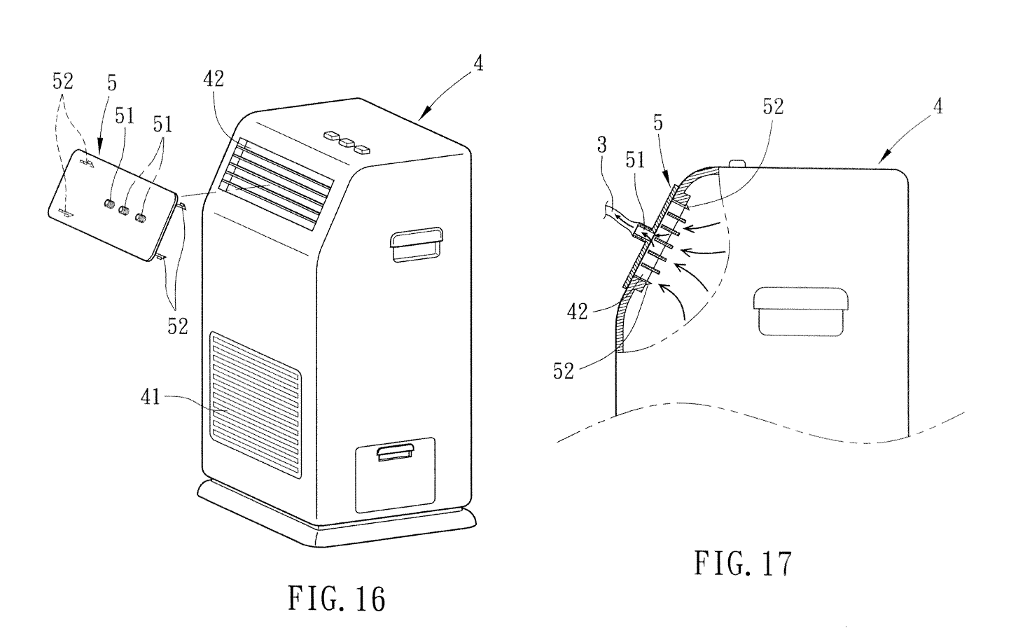

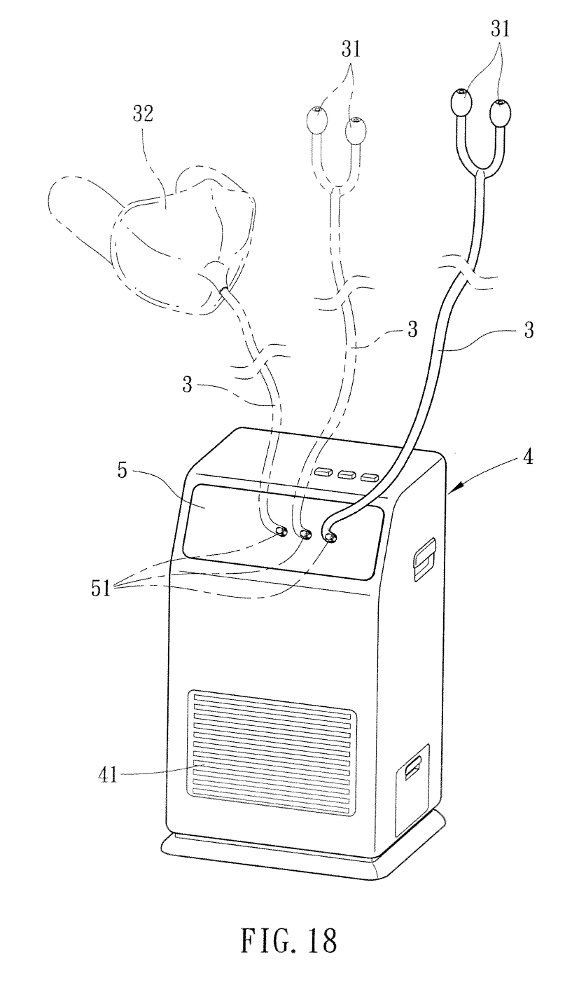

Referring to FIGS. 16˜18, in still another alternate form of the present invention, a shutting device 5 is fastened to the air output port 42 of a conventional air purifier 4 to block the passage of the air output port 42. The shutting device 5 comprises at least one, for example, three air outlets 51, and a plurality of mounting members 52 for allowing quick installation of the shutting device 5 in the air output port 42 of the air purifier 4. After installation of the shutting device 5 in the air output port 42 of the air purifier 4, external air enters the air purifier 4 through the air input port 41 and then purified by the internal mechanism of the air purifier 4, and then purified air is guided out of the air output port 42 of the air purifier 4 through the air outlets 51 of the shutting device 5. Thus, breathing tubes 3 that have a respiratory device, for example, a pair of respiratory nosepieces 31 or a respiratory mask 32 at one end thereof can be connected to the air outlets 51 of the shutting device 5 respectively for enabling users to breathe in purified air from the air purifier 4 through the breathing tubes 3.

According to the aforesaid description, the invention enables a conventional air purifier to be quickly changed into a respiratory system for one or a number of individuals to breathe in purified air from the air purifier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An air purifier air outlet structure, comprising an air purifier having an air input port and an air output port located on a housing thereof, characterized in that at least one air outlet is located on the housing of said air purifier adjacent to said air output port of the air purifier; by means of the said component parts, intake air passing through said air input port into the inside of said air purifier is purified by said air purifier and then guided out of said air purifier through said air output port via said at least one air outlet.

2. The air purifier air outlet structure as claimed in claim 1, further comprising a shutting device adapted to block said air output port; by means of the use of said shutting device to block said air output port, intake air passing through said air input port into the inside of said air purifier is purified by said air purifier and then guided out of said air purifier through said at least one air outlet.

3. The air purifier air outlet structure as claimed in claim 1, further comprising at least one breathing tube respectively connected to said at least one air outlet, each said breathing tube having one end thereof connected to one said air outlet and an opposite end thereof terminating in a respiratory device for enabling a user to breathe in purified air from said air purifier through the breathing tube; by means of connecting one said breathing tube to one said air outlet, said air purifier is changed into a respiratory system for use in an office, house, car, factory or hospital as a personal respiratory system to provide purified air for breathing by an individual user.

4. The air purifier air outlet structure as claimed in claim 1, wherein said at least one air outlet includes multiple air outlets.

5. The air purifier air outlet structure as claimed in claim 3, wherein said respiratory device of said breathing tube is a pair of nosepieces.

6. The air purifier air outlet structure as claimed in claim 3, wherein said respiratory device of said breathing tube is a respiratory mask.

7. The air purifier air outlet structure as claimed in claim 1, wherein said shutting device is a louver shutter installed in said air output port of said air purifier and biasable to close/open said air output port.

8. The air purifier air outlet structure as claimed in claim 1, wherein said shutting device is a shutter formed of two sets of shutter slats and installed in said air output port of said air purifier, one said set of shutter slats being movable relative to the other said set of shutter slats between a close position to close said air output port and an open position to open said air output port.

9. The air purifier air outlet structure as claimed in claim 1, wherein said shutting device carries said at least one air outlet.
